(19) United States
(12) Patent Application Publication
(10) Pub. No.: US 2026/0327037 A1
(43) Pub. Date: Oct. 22, 2026

(54) REEL AND MANUFACTURING METHOD THEREOF

(71) Applicant: JF POLYMERS (SUZHOU) CO., LTD., Suzhou (CN)

(72) Inventor: Pete Eugene Webb, JR., Houston, TX (US)

(73) Assignee: JF POLYMERS (SUZHOU) CO., LTD., Suzhou (CN)

(21) Appl. No.: 19/183,729

(22) Filed: Apr. 18, 2025

(51) Int. Cl. B65H 75/28; B33Y 40/00; B65H 75/14; B65H 75/50

(52) U.S. Cl. CPC B65H 75/28; B33Y 40/00; B65H 75/14; B65H 75/50; B65H 2701/31

(57) ABSTRACT

A reel and a method for manufacturing a reel are provided. The reel comprises a barrel, a first flange, a second flange, and at least one filament clip. The barrel is configured to wind a filament and comprises a first end and a second end. The first flange is connected to the first end and perpendicular to a first axis of the barrel, the first flange comprises a first inner wall and a first outer wall. The second flange is connected to the second end and perpendicular to the first axis, the second flange comprises a second inner wall and a second outer wall. An accommodation space for the filament is formed between the first outer wall and the second outer wall. The filament clip is configured to secure the free end of the filament entirely within the accommodation space.

### TECHNICAL FIELD

The present disclosure relates to the field of reel technology, and in particular to a reel and a manufacturing method thereof.

### BACKGROUND

As technological advancements continue to unfold, an increasingly diverse array of filaments has emerged, greatly enriching both everyday life and industrial applications. These innovations have brought convenience to a wide range of fields. In the realm of 3D printing, for example, filaments are critical consumables integral to the operation of many printers. After production, filaments are typically wound onto reels to form spools, streamlining their transportation, storage, and application. However, when wound onto a reel, the free end of the filament can easily slip off, leading to tangling. To address this issue, manufacturers have traditionally incorporated one or more holes into the reel's flange, allowing the free end of the filament to be inserted from the inside. The filament's elasticity and friction with the flange help secure the free end within the hole, anchoring it to the reel. Nevertheless, this approach often results in the free end protruding beyond the flange, leaving it exposed and unprotected. Consequently, during storage, transportation, or use, the exposed free end becomes susceptible to wear, breakage, or contamination, ultimately compromising the filament’s performance and usability.

Consequently, it is necessary to provide a new reel designed to securely fix the filament’s free end, while ensuring that no portion of the filament extends beyond the flange, thereby maintaining its protection.

The content in the background is merely information known to the inventor personally, and does not represent that the above information had entered the public domain before the filing date of the present disclosure, nor does it represent that it can constitute the prior art of the present disclosure.

### SUMMARY

The present disclosure provides a reel and a method for manufacturing a reel, so as to address issues found in related technologies.

In a first aspect, the present disclosure provides a reel, comprising a barrel, configured to wind a filament, where the barrel comprises a first end and a second end; a first flange, connected to the first end and perpendicular to a first axis of the barrel, where the first flange comprises a first inner wall and a first outer wall and a diameter of the first flange is greater than a diameter of the barrel; a second flange, connected to the second end and perpendicular to the first axis, where the second flange comprises a second inner wall and a second outer wall, and a diameter of the second flange is greater than the diameter of the barrel, and an accommodation space is formed between the first outer wall and the second outer wall; and at least one filament clip, configured to fix the entire free end of the filament within the accommodation space, where the at least one filament clip comprises a free end of the filament clip and a connecting end of the filament clip connected to the first flange.

In a second aspect, the present disclosure provides a method for manufacturing a reel, comprising: obtaining a barrel, a first flange, and a second flange; generating at least one filament clip on the first flange; and assembling the barrel, the first flange, and the second flange into a reel, where the reel comprises: the barrel, configured to wind a filament, where the barrel comprises a first end and a second end, the first flange, connected to the first end and perpendicular to a first axis of the barrel, where the first flange comprises a first inner wall and a first outer wall and a diameter of the first flange is greater than a diameter of the barrel, the second flange, connected to the second end and perpendicular to the first axis, where the second flange comprises a second inner wall and a second outer wall, and a diameter of the second flange is greater than the diameter of the barrel, and an accommodation space is formed between the first outer wall and the second outer wall, and the at least one filament clip, configured to fix the entire free end of the filament within the accommodation space, where the at least one filament clip comprises a free end of the filament clip and a connecting end of the filament clip connected to the first flange.

In a third aspect, the present disclosure provides a method for manufacturing a reel, comprising: obtaining a reel comprising a barrel, a first flange, and a second flange; and generating at least one filament clip on the first flange, such that the reel comprises: the barrel, configured to wind a filament, where the barrel comprises a first end and a second end, the first flange, connected to the first end and perpendicular to a first axis of the barrel, where the first flange comprises a first inner wall and a first outer wall and a diameter of the first flange is greater than a diameter of the barrel, the second flange, connected to the second end and perpendicular to the first axis, where the second flange comprises a second inner wall and a second outer wall, and a diameter of the second flange is greater than the diameter of the barrel, and an accommodation space is formed between the first outer wall and the second outer wall, and the at least one filament clip, configured to secure the entire free end of the filament within the accommodation space, where the at least one filament clip comprises a free end of the filament clip and a connecting end of the filament clip connected to the first flange.

In summary, the reel introduced in the present disclosure features a wire clip designed to move relative to the first flange, allowing it to alternate between multiple working positions. By switching between different working positions, the wire clip is able to secure the free ends of filaments of different sizes, or is able to secure the free ends of filaments located in different positions. As a result, the clip’s versatility and compatibility with various filament types and free ends thereof are significantly improved. Moreover, during a filament winding process, the wire clip can retract, reducing its spatial footprint on the reel and promoting a more seamless and efficient winding operation.

Other functions of the reel and the method for manufacturing the reel provided by the present disclosure will be partially listed in the following description. According to the description, the contents introduced in the following figures and examples will be obvious to a person skilled in the art. The inventive aspects of the reel and the method for manufacturing the reel provided by the present disclosure can be fully explained through the practice or use of the methods, devices, and combinations provided in the detailed examples below.

### BRIEF DESCRIPTION OF THE DRAWINGS

To illustrate the technical solutions in the embodiments of the present disclosure, the drawings for the description of the embodiments will be briefly introduced below. It is obvious that the drawings described below are only some embodiments of the present disclosure. For a person skilled in the art, other drawings can also be obtained based on these drawings without creative work.

FIG. 1 is a schematic view of the structure of a reel according to some exemplary embodiments of the present disclosure;

FIG. 2 is a left view of a reel according to some exemplary embodiments of the present disclosure;

FIG. 3 is a schematic view of the assembly structure of a first flange and a filament clip according to some exemplary embodiments of the present disclosure;

FIG. 4 is a partial enlarged view of part B in FIG. 3;

FIG. 5 is a partial enlarged view of part C in FIG. 2;

FIG. 6 is a partial enlarged view of part E in FIG. 2;

FIG. 7 is a partial enlarged view of part G in FIG. 2;

FIG. 8 is a schematic view of the assembly structure of a first flange and a filament clip according to some exemplary embodiments of the present disclosure;

FIG. 9 is a schematic view of the assembly structure of a first flange and a filament clip according to some exemplary embodiments of the present disclosure;

FIG. 10 is a partial enlarged view of part F in FIG. 2;

FIG. 11 is a schematic view of the assembly structure of a first flange and a filament clip according to some exemplary embodiments of the present disclosure;

FIG. 12 is a flowchart of a method for manufacturing a reel according to some exemplary embodiments of the present disclosure;

FIG. 13 is a schematic view of a producing process of a filament clip of a reel according to some exemplary embodiments of the present disclosure;

FIG. 14 is a flowchart of a method for producing a reel according to some exemplary embodiments of the present disclosure; and

FIG. 15 is a schematic view of a producing process of a filament clip of a reel according to some exemplary embodiments of the present disclosure.

### DETAILED DESCRIPTION

The following description provides specific application scenarios and requirements of the present disclosure, with the aim of enabling a person skilled in the art to make and use the content of the present disclosure. Various modifications to the disclosed embodiments will be obvious to a person skilled in the art, and the general principles defined herein may be applied to other embodiments and applications without departing from the principles and scope of the present disclosure. Therefore, the present disclosure is not limited to the exemplary embodiments illustrated herein, but rather covers the broadest scope consistent with the claims.

The terms used herein are only for the purpose of describing particular exemplary embodiments and are not intended to be limiting. For example, unless the context clearly indicates otherwise, the singular forms “a,” “an,” and “the” as used herein are also intended to include the plural forms. When used in the present disclosure, the terms “comprise,” “include,” and/or “contain” indicate the presence of related features, integers, steps, operations, elements, and/or components, but do not preclude the presence or addition of one or more other features, integers, steps, operations, elements, components, and/or groups in a system or method.

In view of the following description, these features of the present disclosure and other features, as well as the operation and function of related elements of the structure, and the economy of combination and manufacture of components, can be significantly improved. With reference to the drawings, all of these form part of the present disclosure. However, it should be understood that the drawings are provided for purposes of illustration and description only and are not intended to limit the scope of the present disclosure. It should also be understood that the drawings are not drawn to scale.

The flowcharts used in the present disclosure illustrate operations implemented by a system according to some exemplary embodiments of the present disclosure. It should be understood that the operations of the flowcharts may be implemented out of order. Rather, the operations may be performed in reverse order or simultaneously. Furthermore, one or more additional operations may be added to the flowcharts; one or more operations may be removed from the flowcharts.

In the present disclosure, the expression “X comprises at least one of A, B, or C” means that X comprises at least A, or X comprises at least B, or X comprises at least C. In other words, X may comprise only any one of A, B, or C, or any combination of A, B, and C, as well as other possible contents/elements. The any combination of A, B, and C herein may be A, B, C, AB, AC, BC, or ABC.

In the present disclosure, unless explicitly stated otherwise, the association between structures may be either a direct association or an indirect association. For example, when it is described that “A is connected to B,” unless it is explicitly stated that A is directly connected to B, it should be understood that A may be directly connected to B or indirectly connected to B; similarly, when it is described that “A is above B,” unless it is explicitly stated that A is directly above B (A and B are adjacent and A is above B), it should be understood that A may be directly above B or indirectly above B (there may be other elements between A and B, and A is above B).

With advancements in technology, a wide variety of filaments have emerged, enriching both everyday life and industrial production with significant convenience. For instance, in 3D printing, filaments are widely utilized as consumables by many printers. Once manufactured, these filaments are typically wound onto reels to form spools, simplifying their transportation, storage, and application. However, in existing designs, a common challenge persists: the free ends of the filaments often slip off the reel, resulting in tangling. Consequently, there is a clear need to develop a new reel design capable of securely anchoring the filament’s free end.

In light of the foregoing, the present disclosure provides a reel and a method for manufacturing the reel. The reel comprises a barrel, a first flange, a second flange, and at least one filament clip. The barrel is used for winding a filament and comprises a first end and a second end. The first flange is connected to the first end and perpendicular to a first axis of the barrel, with the first flange comprising a first inner wall and a first outer wall, and having a diameter greater than a diameter of the barrel. The second flange is connected to the second end and perpendicular to the first axis, with the second flange comprising a second inner wall and a second outer wall, and having a diameter greater than the diameter of the barrel. An accommodation space for the filament is formed between the first outer wall and the second outer wall. The filament clip comprises a free end of the filament clip and a connecting end of the filament clip connected to the first flange. The filament clip is configured to fix/secure the filament fully within the accommodation space. For example, the free end of the filament clip can be designed to allow the filament clip to move relative to the first flange, thereby allowing the free end of the filament clip to switch between different working positions. By switching between different working positions, the filament clip can secure the free end of filaments of different sizes or secure the free end of filaments located in different positions. This can improve the compatibility of the filament clip with the free end of the filament. In addition, during a process of winding the filament, the filament clip has a reduced spatial footprint on the reel to facilitate the winding of the filament.

It should be noted that the term “filament” in this disclosure may be any thin, long, and flexible wire-like product, and may be made of/from metal, plastic, organic or any other times of materials, or combination thereof. The reel provided herein can also be used for winding other types of filaments/wires/cables than 3D printing filaments. The filament clip can secure the free end of the filaments/wires/cables. For example, the reel may be used for winding a cable, and the filament clip can secure the free end of the cable.

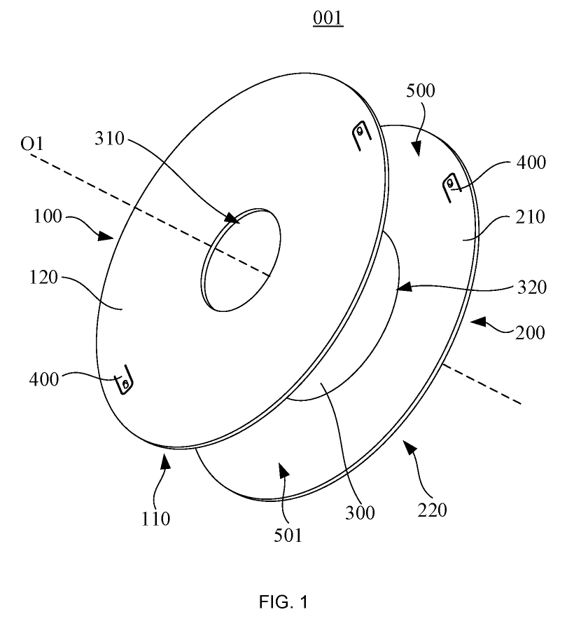

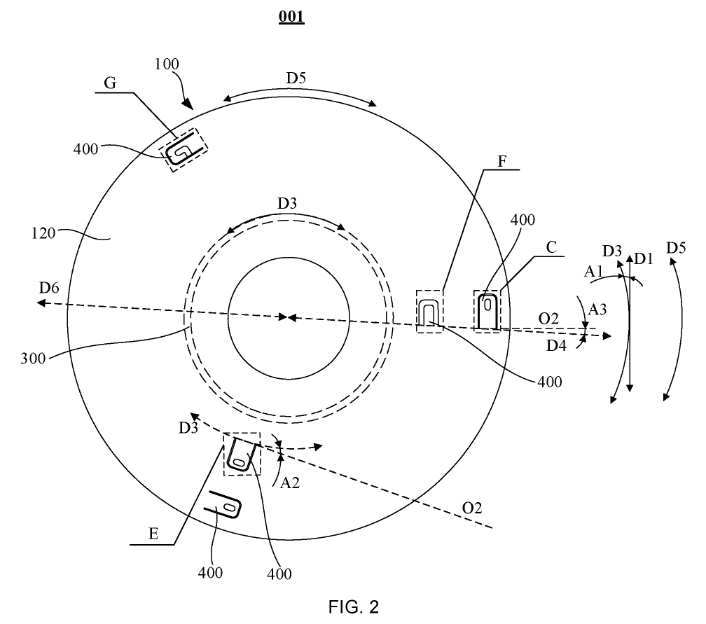

FIG. 1 is a schematic view of the structure of a reel according to some exemplary embodiments of the present disclosure. FIG. 2 is a left view of a reel according to some exemplary embodiments of the present disclosure.

As shown in FIGS. 1 and 2, a reel 001 may comprise a barrel 300, a first flange 100, a second flange 200, and at least one filament clip 400.

The barrel 300 may be used for winding a filament and comprises a first end 310 and a second end 320. The barrel 300 extends along a first axis O1. The first end 310 and the second end 320 are two opposite ends of the barrel 300. The barrel 300 may be cylindrical, triangular prism-shaped, and/or rectangular prism-shaped, which is not limited herein. Next, the barrel 300 is described with a cylindrical barrel 300 as an example. In some exemplary embodiments, the barrel 300 may be made of paper, plastic, metal, etc., or any combinations thereof.

The first flange 100 is connected to the first end 310 and is perpendicular to the first axis O1 of the barrel 300. The first flange 100 may be a plate-like structure. In the radial direction D4 of the barrel 300, the size/diameter of the first flange 100 is greater than the size/diameter of the barrel 300 so as to protect the filament wound on the barrel. The first flange 100 comprises a first inner wall 110 and a first outer wall 120. Specifically, the first inner wall 110 faces the barrel 300, and the first outer wall 120 faces away from the barrel 300.

The first flange 100 may be circular, square, or in other shapes. The present disclosure describes the first flange 100 using a circular first flange 100 as an example. In some exemplary embodiments, the first flange 100 is coaxial with the barrel 300. Therefore, the circumferential direction D5 of the first flange 100 is consistent with and/or parallel to the circumferential direction D3 of the barrel 300; the radial direction D6 of the first flange 100 is consistent with and/or parallel to the radial direction D4 of the barrel 300. In some exemplary embodiments, the first flange 100 can be made of paper, plastic, metal, other materials, or combinations thereof. The material can be the same as or different from that of the barrel.

The second flange 200 is connected to the second end 320 and is perpendicular to the first axis O1. The second flange 200 may be a plate-like structure. In the radial direction D4 of the barrel 300, the size/diameter of the second flange 200 is greater than the size/diameter of the barrel 300 so as to protect the filament wound on the barrel. The second flange 200 comprises a second inner wall 210 and a second outer wall 220. Specifically, the second inner wall 210 faces the barrel 300, and the second outer wall 220 faces away from the barrel 300.

The second flange 200 may be circular, square, or in other shapes. The present disclosure describes the second flange 200 using a circular second flange 200 as an example. In some exemplary embodiments, similar to the first flange 100, the second flange 200 can be coaxial with the barrel 300. Therefore, the circumferential direction of the second flange 200 is consistent with and/or parallel to the circumferential direction D3 of the barrel 300; the radial direction of the second flange 200 is consistent with the radial direction D4 of the barrel 300. In some exemplary embodiments, the second flange 200 can be made of paper, plastic, metal, other materials, or combinations thereof. The material can be the same as or different from that of the barrel. The shape and material of the second flange 200 may be the same as or different from those of the first flange 100.

An accommodation space 500 for the filament may be formed between the first outer wall 120 and the second outer wall 220. The accommodation space 500 may comprise a first accommodation space 501. The first accommodation space 501 may be formed between the first inner wall 110 and the second inner wall 210, and the main portion or the entirety of the filament may be located within the first accommodation space 501.

In some exemplary embodiments, the accommodation space 500 may further comprise a second accommodation space, which may be located between the first inner wall 110 and the first outer wall 120. For example, the following accommodation recess 111 may serve as the second accommodation space.

The filament clip 400 is configured to secure/fix/clamp fix the entire free end of the filament within the accommodation space, so as to prevent loosening/slipping off of the filament. In particular, the filament clip 400 can fix the entire free end of the filament within the accommodation space, without letting the free end of the filament surpassing the first outer wall 120. Here, the free end of the filament refers to the portion between the end point of the filament and the point where the filament starts to be wound onto the barrel 300.

When the filament is not in use, the free end of the filament may be removably secured by the filament clip 400. The filament clip 400 may be in contact with the free end of the filament to restrict/limit the movement of the free end of the filament through friction. In some exemplary embodiments, the filament clip 400 may undergo elastic deformation and apply an elastic force to the free end of the filament. The limiting manner by which the filament clip 400 restricts the free end of the filament will be described in detail below.

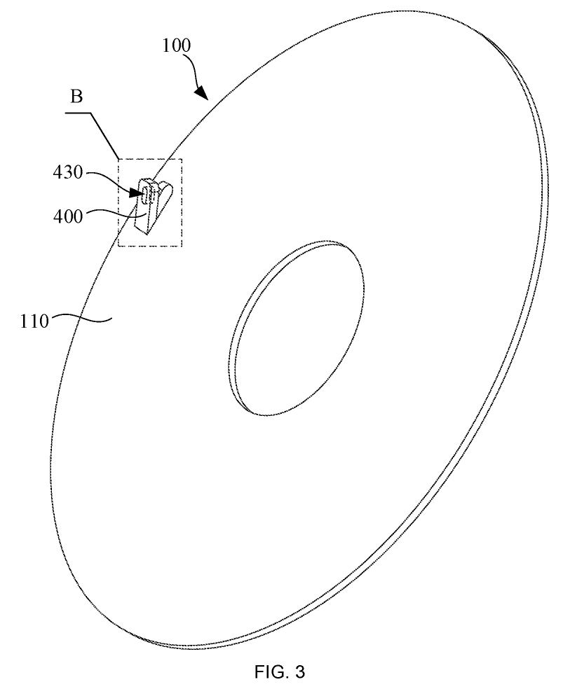

FIGS. 3-11 illustrate various embodiments of the filament clip 400 according to the present disclosure.

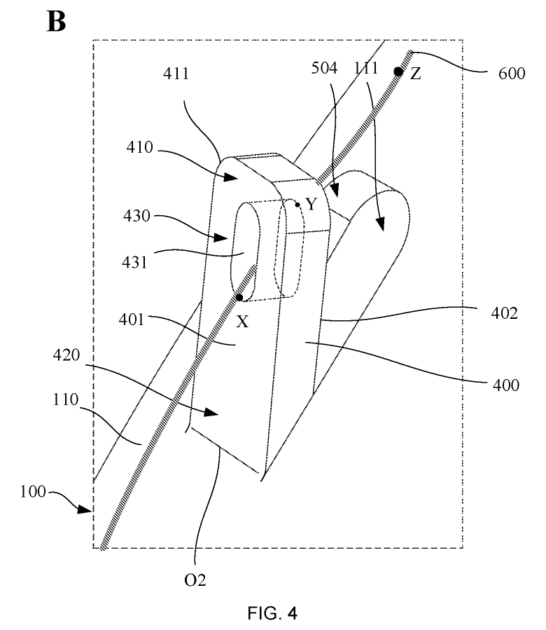

In some exemplary embodiments, as shown in FIGS. 3-4, the filament clip 400 is plate-shaped. This facilitates the generating/processing of the filament clip 400 and also reduces the space occupied by the filament clip 400 on the reel 001. For example, the filament clip 400 may be a tongue-like part or a reed-like part.

FIG. 3 is a schematic diagram of the assembly structure of the first flange and the filament clip according to some exemplary embodiments of the present disclosure. FIG. 4 shows a partial enlarged view of part B in FIG. 3. In some exemplary embodiments, the filament clip 400 may be a structure similar to a cantilever beam or a beam structure with one end hinged and the other end free. As shown in FIGS. 1, 3, and 4, the filament clip 400 may comprise a free end 410 of the filament clip and a connecting end 420 of the filament clip. The connecting end 420 of the filament clip may be connected to the first flange 100. The free end 410 of the filament clip is located at the other end of the filament clip 400, opposite to the connecting end 420 of the filament clip. Compared to the connecting end 420 of the filament clip, the free end 410 of the filament clip has more degrees of freedom of movement. For example, the free end 410 of the filament clip may be displaced relative to the first flange 100 through the elastic deformation of the filament clip 400; alternatively, the connecting end 420 of the filament clip may be rotatably connected to the first flange 100, such that the free end 410 of the filament clip may be displaced by rotating around the connecting end 420 of the filament clip. When the filament needs to be secured/fixed, a user only needs to push the filament clip 400, causing the free end 410 of the filament clip to generate sufficient displacement, thereby enabling the filament clip to fix the free end of filaments of different sizes, or to fix the free end of the filament located in different positions. When the free end 410 of the filament clip is tightly against or enters the first inner wall 110, the space occupied by the filament clip 400 in the first accommodation space 501 may be reduced. In this way, the inner wall of the first flange is smooth or substantially smooth, and the filament will not be obstructed by the filament clip 400 on the first inner wall 110 during the process of winding onto or from the reel.

In some exemplary embodiments, as shown in FIG. 3 and 4, the free end 410 of the filament clip may have a rounded edge 411. During the forming process of the free end 410 of the filament clip, the rounded edge 411 may reduces the potential of user injury and mitigates stress concentration, thereby enhancing the clip's safety and structural integrity.

As shown in FIG. 3, the connecting end 420 of the filament clip may be integrally formed with the first flange 100 integrally. For example, the connecting end 420 of the filament clip is connected to the first flange 100 through injection molding. In another example, the filament clip 400 is formed on the first flange 100 by cutting or punching, and thus belong to the same plate material (e.g., paperboard or plastic sheet). During and after the cutting process, the connecting end 420 of the filament clip remains connected to the first flange 100. The cutting process for forming the filament clip 400 with the first flange 100 will be described in detail below.

In some embodiments, the filament clip 400 and the first flange 100 are formed by cutting from the same sheet of paper. Upon initial use, a user may push the filament clip 400 towards the accommodation space 500, causing the connecting end 420 of the filament clip of the filament clip to bend at the second axis O2 relative to the first flange 100, thereby forming a crease. When the first flange 100 is made of paper, the second axis O2 may be approximately regarded as a rotation axis of the filament clip 400 after bending. The filament clip 400 then may perform an approximately pivot movement relative to the second axis O2. When the filament clip 400 pivot around the second axis O2, the free end 410 of the filament clip may be displaced with respect to the first flange 100.

When the filament clip 400 is in the initial position, the free end 410 of the filament clip may be located relatively close to the first inner wall 110, for example, the free end of the filament clip may be coplanar with the first inner wall 110. In this way, the filament clip 400 does not obstruct the filament 600 during the winding process , thereby improving the efficiency of filament winding.

When the filament clip 400 is in a working position, the free end 410 of the filament clip may protrude from the first inner wall 110 to facilitate securing the free end of the filament 600.

As shown in FIGS. 1, 3, and 4, an accommodation recess 111 may be arranged on the first inner wall 110 of the first flange 100 to accommodate the filament clip 400. Further, along the thickness direction of the first flange 100, the accommodation recess 111 may penetrate through the first flange 100. Such design may facilitate the processing of the accommodation recess 111. For example, the filament clip 400 and the first flange 100 may be formed simultaneously from the same sheet/plate by laser or punching cutting. The break in the sheet/plate may respectively form the accommodation recess 111 and the filament clip 400. Therefore, the initial position of the filament clip 400 is coplanar with the accommodation recess 111. Moreover, since the contour of the accommodation recess 111 is formed simultaneously with the contour of the filament clip 400 during the cutting/punching process, the contour of the accommodation recess 111 may match the contour of the filament clip 400. Of course, the contour of the accommodation recess 111 may also be formed by cutting/punching to be different from that of the filament clip 400, which is not limited herein. Since they are formed by cutting/punching from the same sheet/plate, the thickness of the filament clip 400 is generally consistent with the thickness of the first flange 100.

The accommodation recess 111 may be in communication with the first accommodation space 501. As described before, since the accommodation recess 111 is located between the first inner wall 110 and the first outer wall 120, the space within the accommodation recess 111 may belong to the second accommodation space.

As shown in FIG. 4, in some exemplary embodiments, the filament clip 400 may comprise a first side 401 and a second side 402. The first side 401 faces the accommodation space 500. The second side 402 faces the first outer wall 120. In addition, as shown in FIGS. 1, 3, and 4, the filament clip 400 may comprise a filament channel 430 to fix/secure the free end of the filament 600. For example, in some exemplary embodiments, the filament channel 430 is a through hole that passes through the first side 401 and the second side 401.

The position of the filament clip 400 may switch between being entirely within the accommodation recess 111 (i.e., the second accommodation space) and being at least partially located within the first accommodation space 501. For example, when the filament clip 400 is in the initial position (such as when the reel 001 has just been manufactured), the filament clip 400 is entirely located within the accommodation recess 111 (i.e., the second accommodation space). The first side 401 is coplanar with the first inner wall 110, the second side 402 is coplanar with the first outer wall 120, and there is no height difference between the free end 410 of the filament clip and the first inner wall 110. In this way, since there is no protrusion on the surface of the first inner wall 110, the filament clip 400 does not obstruct winder and unwinding of the filament 600, thereby improving the efficiency of filament winding/unwinding. After the filament winding is completed, the free end 410 of the filament clip may extend from the accommodation recess 111 into the first accommodation space 501 so as to fix/secure the free end of the filament. At this time, the filament clip 400 is in the working position. The filament clip 400 is at least partially located within the first accommodation space 501 in the working position. As shown in FIG. 4, the free end 410 of the filament clip may be displaced by rotating about the second axis O2, thereby forming a predetermined gap 504 between the free end 410 of the filament clamp and the first inner wall 110.

The filament channel 430 is in communication with the predetermined gap 504. To secure/fix/clamp the filament 600, the free end of the filament 600 enters the filament channel 430 from the first side 401 of the filament clip 400, exits the filament channel 430 from the second side 402, and then enters in the accommodation space 500 through the predetermined gap 504. The filament channel 430 may abut against the filament 600 to generate a frictional force that hinders the movement of the free end of the filament 600, so that the filament clip 400 may restrict/limit the movement of the free end of the filament 600, thereby producing a fixing effect.

For example, as shown in FIGS. 1, 3, and 4, the filament channel 430 may comprise a restriction hole 431, through which the filament 600 enters from the first side 401 and exits from the second side 402. A first edge may be formed between the restriction hole 431 and the first side 401. A second edge may be formed between the restriction hole 431 and the second side 402. When the filament 600 passes through the restriction hole 431, it abuts against point X on the first edge and point Y on the second edge. After the free end of the filament 600 passes through the predetermined gap 504, it abuts against a point Z on the first inner wall 110. Point X, point Y, and point Z, act jointly to clamp the free end of the filament 600.

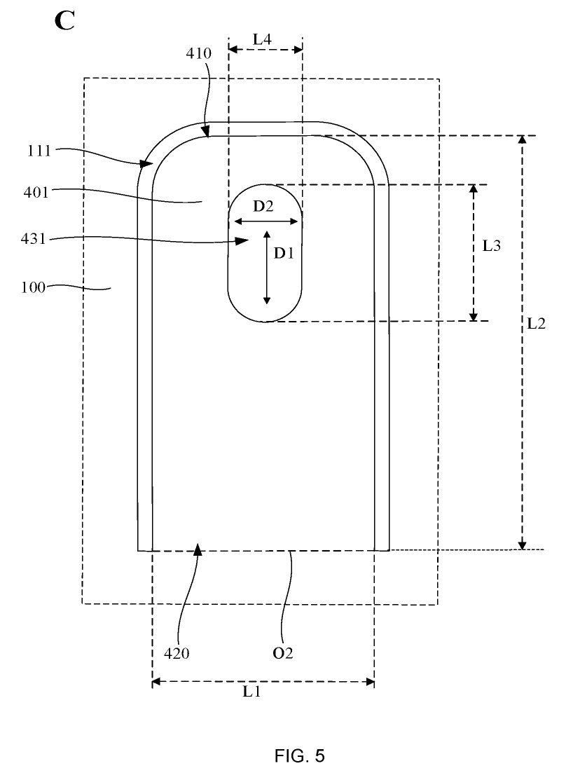

FIG. 5 illustrates a partial enlarged view of part C in FIG. 2. According to some exemplary embodiments, as shown in FIGS. 2 and 5, the restriction hole 431 may have a major diameter L3 along the major axis D1 and a minor diameter L4 along the minor axis D2. The major axis D1 and the minor axis D2 may be perpendicular to each other. The major diameter L3 is larger than the minor diameter L4, and the size of the minor diameter L4 may be adapted to the diameter of the filament 600 to allow the filament 600 to pass through the restriction hole 431 at an angle.

In some exemplary embodiments, the size of the major diameter L3 may be 1.5 to 2.5 times the size of the minor diameter L4. In some exemplary embodiments, the major diameter L3 of the restriction hole 431 may be 3 mm to 8 mm, and the minor diameter L4 of the restriction hole 431 may be 1.5 mm to 4 mm. Moreover, the major diameter L3 of the restriction hole 431 may be 4 mm to 6 mm, and the minor diameter L4 of the restriction hole 431 may be 2 mm to 3 mm. In this way, the size of the restriction hole 431 may be adapted to the size and hardness of the filament, facilitating the passage of the filament through the restriction hole 431, while also helping the restriction hole 431 to clamp/restrict the filament. In some exemplary embodiments, along the second axis O2, the width dimension L1 of the filament clip 400 may be 5 mm to 10 mm. Perpendicular to the second axis O2, the length dimension L2 of the filament clip 400 may be 12 mm to 18 mm. This ensures that the size of the filament clip 400 is not too large, while allowing the filament clip 400 to effectively fix the free end of a filament with a diameter in the range of 1.5 mm to 4 mm.

In some exemplary embodiments, both ends of the restriction hole 431 may be semicircular, so that the contour of both ends of the restriction hole 431 may be adapted to the contour of the filament. This facilitates full contact between the restriction hole 431 and the free end of the filament, which may enhance the fixing effect.

In some exemplary embodiments, the major axis D1 generally extends along the circumferential direction D3 of the barrel 300. For example, an angle A1 between the major axis D1 and the circumferential direction D3 of the barrel 300 may be less than or equal to 45°. Specifically, the range of angle A1 between the major axis D1 and the circumferential direction D3 of the barrel 300 may be [0°-30°], [0°-20°], [0°-15°], [0°-10°], or [0°-5°], etc. Moreover, the major axis D1 may be consistent with (parallel or nearly parallel to) the circumferential direction D3 of the barrel 300. In this way, the major axis D1 is relatively close to the circumferential direction D3 of the barrel 300. Before entering the restriction hole 431, the filament generally extends along the circumferential direction D3 of the barrel 300. Therefore, the major axis D1 may be adapted to the extension direction of the filament, facilitating the insertion of the filament into the restriction hole 431.

In some exemplary embodiments as shown in FIGS. 3, 4, and 5, the major axis D1 may be perpendicular or approximately perpendicular to the second axis O2. Accordingly, an angle A3 between the second axis O2 and the radial direction D4 of the barrel 300 is less than or equal to 45°. For example, the angle A3 between the second axis O2 and the radial direction D4 of the barrel 300 may be in the range of [0°-30°], [0°-20°], [0°-15°], [0°-10°], or [0°-5°], etc. For instance, the angle between the second axis O2 and the radial direction D4 of the barrel 300 is 0° or approximately 0°. In this way, the major axis D1 is relatively close to the circumferential direction D3 of the barrel 300. The free end of the filament 600 may be more easily inserted into the restriction hole 431 along the circumferential direction D3 of the barrel 300.

In addition to the design of part C shown in FIG. 2, the filament clip 400 may also be designed in other ways. In some exemplary embodiments, the filament clip 400 may also adopt a design as shown in part E of FIG. 2.

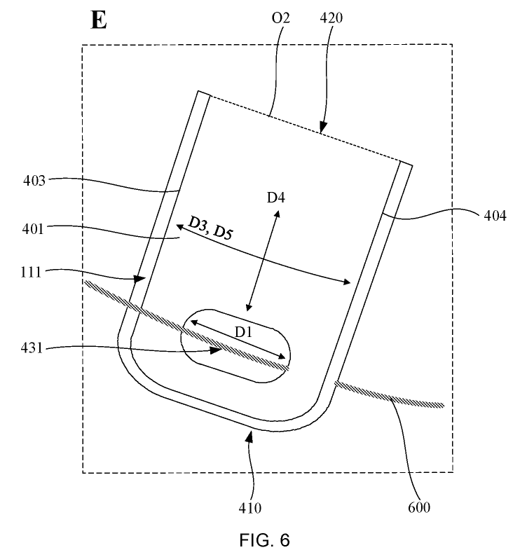

FIG. 6 shows a partial enlarged view of part E in FIG. 2. Similar to the design of part C in FIG. 2, the filament channel 430 in part E may also be designed as a restriction hole 431. The restriction hole 431 also has a major axis and a minor axis. However, unlike the design in part C, in the design of part E, the minor axis of the restriction hole 431 is perpendicular or substantially perpendicular to the second axis O2.

As shown in FIGS. 2 and 6, the major axis D1 of the restriction hole 431 generally extends along the direction of the barrel 300. For example, the angle A1 between the major axis D1 and the circumferential direction D3 of the barrel 300 is less than or equal to 45°. For example, the range of angle A1 may be [0°-30°], [0°-20°], [0°-15°], [0°-10°], or [0°-5°], etc. Furthermore, the major axis D1 may be consistent with the circumferential direction D3 of the barrel 300. In this way, the major axis D1 is relatively close to the circumferential direction D3 of the barrel 300. Before entering the restriction hole 431, the filament generally extends along the circumferential direction D3 of the barrel 300. Therefore, the major axis D1 may be adapted to the extension direction of the filament, facilitating the insertion of the filament into the restriction hole 431.

Accordingly, the second axis O2 of the filament clip 400 may form a preset angle with the circumferential direction D3. For example, the angle A2 between the second axis O2 and the circumferential direction D3 of the barrel 300 is less than or equal to 45°. For example, the range of angle A2 may be [0°-30°], [0°-20°], [0°-15°], [0°-10°], or [0°-5°], etc. For instance, the angle A2 between the second axis O2 and the circumferential direction D3 of the barrel 300 may be 0° or approximately 0° (i.e., the second axis is a tangent to or approximately a tangent to the barrel 300). In this way, the second axis O2 is relatively close to the circumferential direction D3 of the barrel 300. The filament channel 430 extends along the second axis O2.

The filament channel 430 may allow the free end of the filament to enter from the third side 403 and exit from the fourth side 404, remaining within the accommodation space 500. The free end of the filament may be inserted into the filament channel 430 along the circumferential direction D3 of the barrel 300, and then the free end of the filament may be clamped inside the filament channel 430. In some exemplary embodiments, the filament channel 430 may be designed as a restriction hole 431.

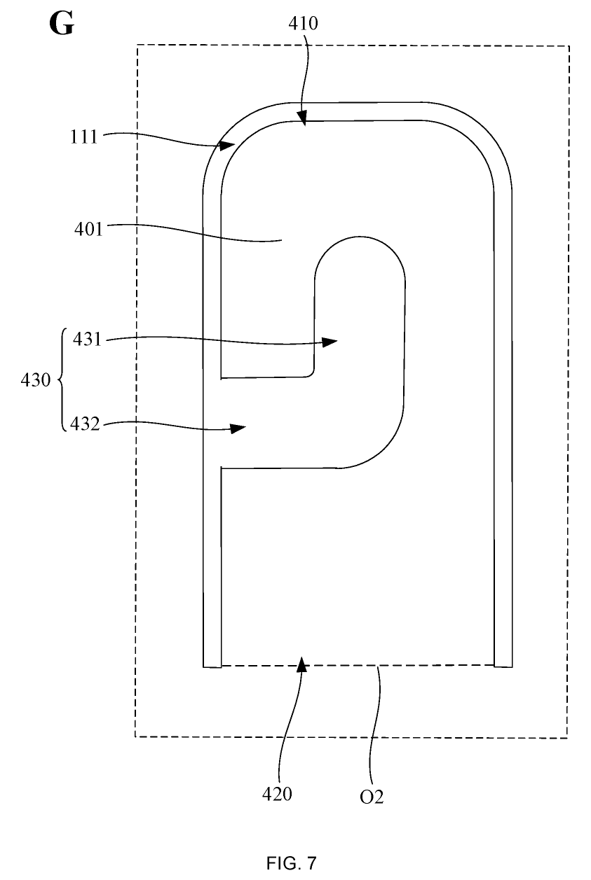

In addition to designing the filament channel 430 as a hole as shown in FIGS. 4, 5, and 6, the filament channel may also be designed in other styles. As shown in part G in FIG. 2, in some exemplary embodiments, the filament channel 430 may also comprise a notch 432, communicating with the restriction hole 431 and the accommodation recess 111, so that the filament channel 430 forms a hook shape. FIG. 7 shows a partial enlarged view of part G in FIG. 2. The free end of the filament may move through the notch 432 into the restriction hole 431. This makes the operation of inserting the free end of the filament into the restriction hole 431 easier and more convenient.

In the above exemplary embodiments, the filament channel of the filament clip 400 is designed as a restriction hole or in a hook shape, with the filament 600 passing through the first side 401 of the filament clip 400 into the accommodation space, and then exiting from the second side 402. In some exemplary embodiments, the filament channel 430 may also be designed in other forms.

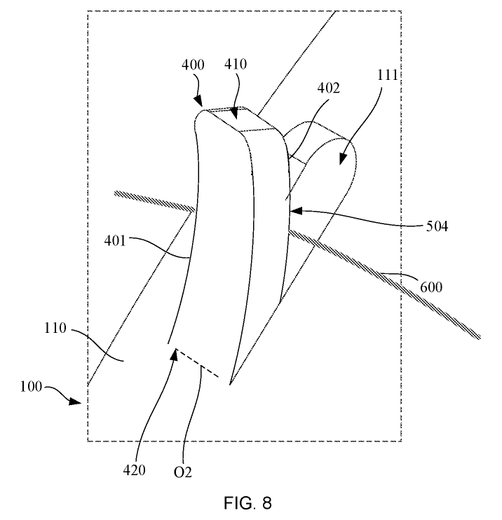

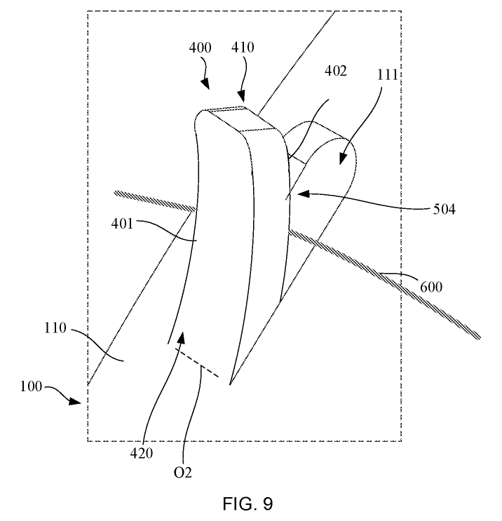

FIGS. 8 and 9 illustrate schematic diagrams of the assembly structure of the first flange 110 and the filament clip 400 according to some exemplary embodiments of the present disclosure. In some exemplary embodiments, the filament clip 400 and the first flange 100 may be formed by cutting from the same piece of material (such as a plastic sheet). In this case, the structure of the filament clip 400 is similar to a cantilever beam. The filament clip 400 and the connecting end 420 of the filament clip may undergo elastic deformation to produce bending. The free end 410 of the filament clip may generate displacement through bending, i.e., displacement around the second axis O2 located at the connecting end 420 of the filament clip. During this process, the filament clip 400 may deflect relative to the first flange 100 and apply an elastic force to the free end of the filament.

The filament clip 400 has an initial position relative to the first flange 100. When the reel 001 is just manufactured, the filament clip 400 is in the initial position, the surface of the filament clip 400 is flush/coplanar with the first inner wall 110 and the first outer wall 120, respectively.

The filament clip 400 may further have at least one working position relative to the first flange 100, for example, as shown in FIG. 8, the filament clip 400 forms a predetermined gap 504 for clamping the filament 600 through bending; or as shown in FIG. 9, the filament clip 400 may have a raised portion 440, and through bending, the raised portion 440 may form the predetermined gap 504 for clamping the filament 600. In this scenario, the predetermined gap 504 serves as the filament channel 430. When in the working position, the filament clip 400 may fix the free end of the filament. For example, when the filament clip 400 is in the working position, the filament clip 400 forms an acute angle with the first inner wall 110. The size of the acute angle may be adjusted, allowing the filament clip 400 to clamp the free end of the filament 600 of different sizes. In this way, the compatibility of the filament clip 400 with the free end of the filament 600 may be further improved.

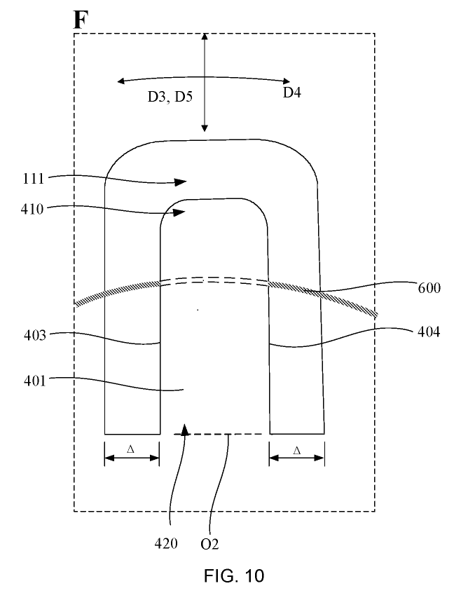

FIG. 10 is a partial enlarged view of part F in FIG. 2, illustrating another design of the filament clip 400. In some exemplary embodiments, as shown in FIGS. 2 and 10, the first inner wall 110 is provided with an accommodation recess 111, and the second side 402 of the filament clip 400 is located within the accommodation recess 111. Along the extension direction of the free end of the filament 600, the width of the filament clip 400 is smaller than the width of the accommodation recess 111, such that both the third side 403 and the fourth side 404 are spaced apart from the inner wall of the accommodation recess 111. Compared with the diameter of the filament 600, the spacing Δ is sufficiently large to allow the free end of the filament to enter the accommodation recess 111 between the third side 403 and the inner wall of the accommodation recess 111, abut against the second side 402 within the recess, and then exit the accommodation recess 111 between the fourth side 404 and the inner wall of the accommodation recess 111. In this way, it is convenient for the filament to pass through the accommodation recess 111.

Meanwhile, the thickness of the filament clip 400 may be smaller than the depth of the accommodation recess 111. The difference between the two dimensions is greater than the diameter of the filament. In this way, when the filament 600 passes between the second side of the filament clip and the first outer wall 120 of the first flange 100, it may be entirely/fully within the second accommodation space, without protruding beyond the first outer wall 120.

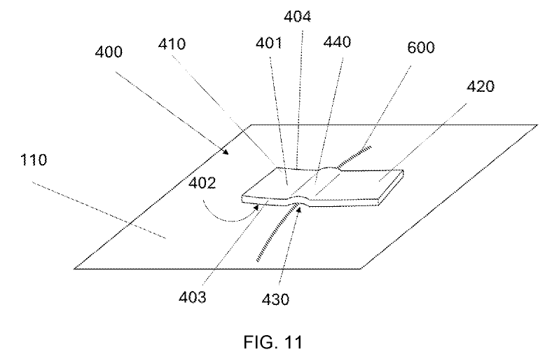

In the above exemplary embodiments, at least a portion of the filament clip 400 may move between the first accommodation space 501 and the second accommodation space. In some exemplary embodiments, the filament clip 400 may always be located within the first accommodation space 501. For example, FIG. 11 illustrates a schematic diagram of the assembly structure of the first flange and the filament clip. In some exemplary embodiments, the filament clip 400 may be an elastic plate-like structure attached to the first inner wall 110. An end of the elastic plate is the connecting end 420 of the filament clip, and the other end thereof is the free end 410 of the filament clip. The connecting end 420 of the filament clip is physically attached to the first inner wall 110. For example, the connecting end 420 of the filament clip may be connected to the first flange 100 by adhesion, welding, or riveting.

In some exemplary embodiments, the filament clip 400 may comprise a third side 403 and a fourth side 404. The third side 403 faces a side in the circumferential direction D3 of the barrel 300. The fourth side 404 faces another side in the circumferential direction D3. In the initial position, the free end 410 of the filament clip may be in contact with the first inner wall 110, or there may be a certain gap between the free end 410 of the filament clip and the inner wall. In the working position, a predetermined gap 504 is present between the free end 410 of the filament clip and the first inner wall 110. Moreover, the predetermined gap 504 may be formed between the second side 402 and the first inner wall 110. For example, a user may pull the free end 410 of the filament clip away from the first inner wall 110 by hand. The free end of the filament may be partially located within the predetermined gap 504. The second side 402 and the first inner wall 110 may clamp/restrict the free end of the filament, thereby producing a securing/fixing effect.

In some exemplary embodiments, as shown in FIG. 11, the filament clip 400 may further comprise a raised portion 440, and the raised portion 440 forms a filament channel 430 along the circumferential direction. The free end of the filament 600 may enter the filament channel 430 from the third side 403 and then exit the filament channel 430 from the fourth side 404. The distance between the filament channel formed by the raised portion 440 and the first inner wall 110 may be smaller than the diameter of the filament, so that the filament clip 400 may clamp the filament 600 onto the first inner wall 110 with the elastic force.

In some exemplary embodiments, as shown in FIG. 1 and 2, the number of filament clips 400 may be multiple (at least two). The plurality of filament clips 400 may be of any combination of the various embodiments described above. For example, the number of filament clips 400 is four. These four filament clips may all have the structure shown in FIG. 5, or all have the structure shown in FIG. 6; or the four filament clips may respectively have the structures shown in FIGS. 5, 6, 9, and 11, and so on.

The multiple filament clips 400 may be distributed in at least one of the following distributions: being distributed at intervals along the circumferential direction D5 of the first flange 100; and/or being distributed at intervals along the radial direction D6 of the first flange 100. For example, if the number of filament clips 400 is three, the three filament clips 400 are distributed at intervals along the circumferential direction D5 of the first flange 100.

In this way, at least two filament clips 400 may be distributed at various positions on the first flange 100, facilitating the fixation of the free end of the filament at different positions. A user may select a corresponding filament clip 400 to fix the free end of the filament based on the position of the free end of the filament. For example, the multiple filament clips 400 may be distributed along the radial direction of the first flange 100. As the filament 600 is used, the filament 600 wound on the barrel 300 becomes less, and the free end of the filament 600 gradually shifts from near the outer peripheral edge of the first flange 100 to closer to the barrel 300. When a relatively large amount of filament 600 remains on the reel 001, the user may select the filament clip 400 located near the outer peripheral edge of the first flange 100 to fix the free end of the filament; while when a relatively small amount of filament 600 remains, the free end of the filament is farther away from the outer peripheral edge of the first flange 100, so the user may then select the filament clip 400 that is farther from the outer peripheral edge of the first flange 100 to fix the free end of the filament.

The filament 600 may be wound on the reel 001 clockwise and counterclockwise. Accordingly, in some exemplary embodiments, the filament clips 400 may be arranged on the first flange 100 clockwise or counterclockwise; or otherwise, some filament clips 400 may be arranged on the first flange 100 clockwise while others may be arranged on the first flange 100 counterclockwise, so that the free end of the filament 600 can be secured regardless of the winding direction thereof.

In some exemplary embodiments, the filament clips 400 may also be provided on the second flange 200. The manner in which the filament clips 400 are provided on the second flange 200 may be the same as the manner in which the filament clips 400 are provided on the first flange 100, and will not be repeated herein.

The above is a schematic solution of the reel 001 disclosed herein. It should be noted that the schematic solution of reel 001 and the technical solution of the preparation method of reel 001 described below belong to the same concept. The detailed contents of the schematic solution of reel 001 and the technical solution of the preparation method of reel 001 described below may refer to each other.

The present disclosure further provides a method P100 for manufacturing the reel 001, which may be used to prepare the reel 001 as described in the above exemplary embodiments. The operator of the method P100 may be a human, automated mechanical equipment, or a combination of both, hereinafter collectively referred to as the user.

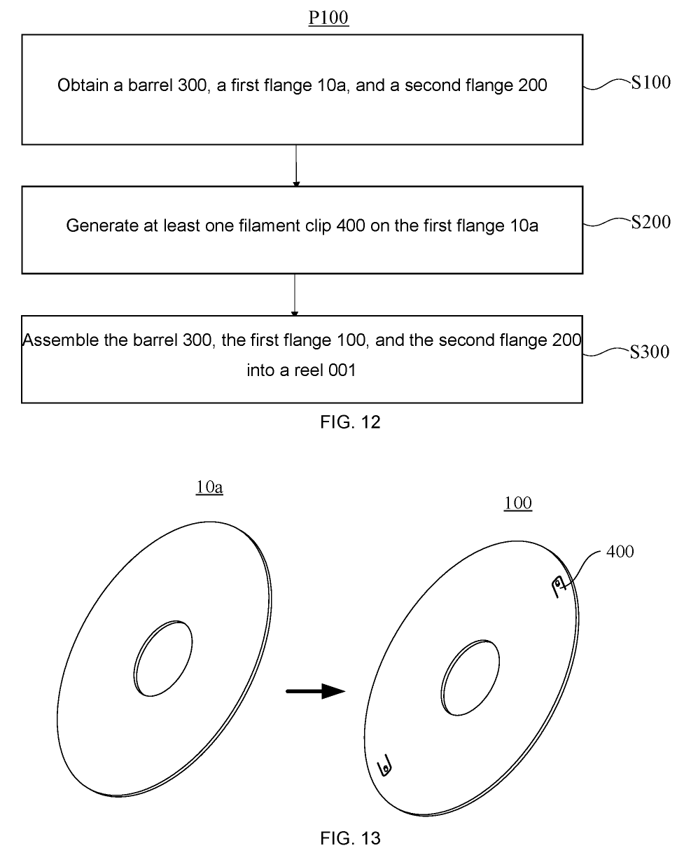

FIG. 12 illustrates a flowchart of a method for manufacturing a reel provided according to some embodiments of the present disclosure. In some exemplary embodiments, as shown in FIG. 12, the method P100 may comprise the following steps S100, S200, and S300.

S100: Obtain a barrel 300, a first flange 10a, and a second flange 200.

S200: Generate at least one filament clip 400 on the first flange 10a.

FIG. 13 illustrates a schematic diagram of the forming process of a filament clip of a reel provided according to some embodiments of the present disclosure. As shown in FIG. 13, a user may generate at least one filament clip 400 by cutting the first flange 10a. The outer contour of the filament clip 400 and the filament channel 430 may both be generated by cutting. The user may cut the first flange 10a using at least one of the following methods: cutting the first flange 10a with a laser; cutting the first flange 10a with a tool; or cutting the first flange 10a with a punch.

S300: Assemble the barrel 300, the first flange 100, and the second flange 200 into the reel 001 as described in the above embodiments.

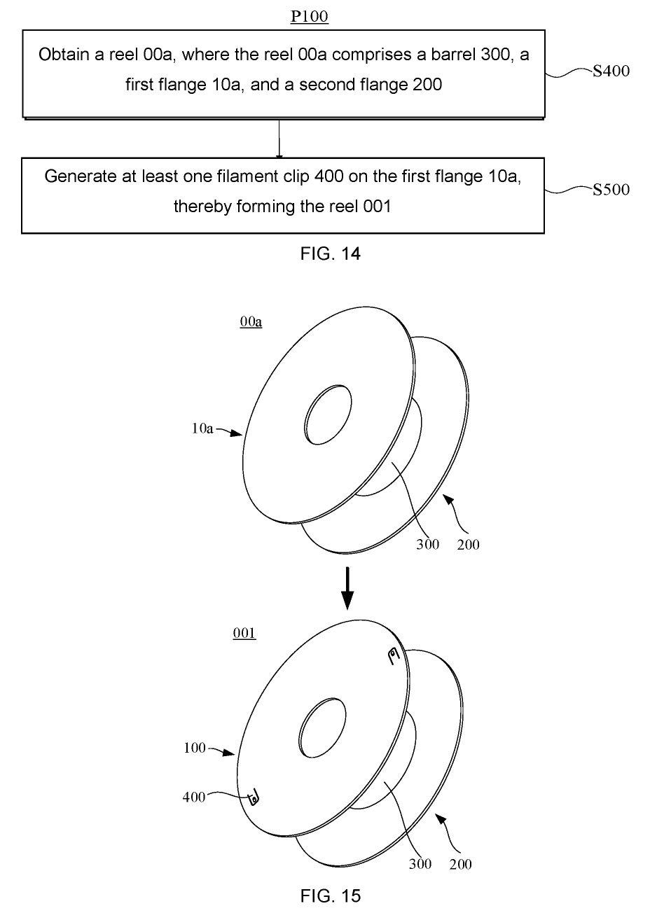

In some exemplary embodiments, FIG. 14 illustrates a flowchart of a method for manufacturing a reel provided according to some embodiments of the present disclosure. As shown in FIG. 14, the method P100 may comprise the following steps S400 and S500.

S400: Obtain a reel 00a, where the reel 00a comprises a barrel 300, a first flange 10a, and a second flange 200.

S500: Generate at least one filament clip 400 on the first flange 10a, thereby forming the reel 001 as described in the above embodiments.

FIG. 15 shows a schematic diagram of a forming process of a filament clip of a reel provided according to some exemplary embodiments of the present disclosure. As shown in FIG. 15, a user may generate at least one filament clip 400 by cutting the first flange 10a. The outer contour of the filament clip 400 and the filament channel 430 may both be generated by cutting. The user may cut the first flange 10a using at least one of the following methods: cutting the first flange 10a with a laser; cutting the first flange 10a with a tool; or cutting the first flange 10a with a punch.

In summary, the filament clip 400 of the reel 001 provided by the present disclosure may move relative to the first flange 100, thereby allowing the filament clip 400 to switch between various working positions. By switching between various working positions, the filament clip 400 may fix/secure the free end of filaments of different sizes or fix/secure the free end of filaments located at different positions. This may improve the compatibility of the filament clip 400 with the free end of the filament. Moreover, during the winding process of the filament, the filament clip 400 may reduce its spatial footprint on the reel 001, facilitating the winding of the filament.

The foregoing describes specific exemplary embodiments of the present disclosure. Other embodiments are also within the scope of the appended claims. In some cases, the actions or steps recited in the claims may be performed in an order different from that in the embodiments and still achieve the desired results. Additionally, the processes depicted in the drawings do not necessarily require the specific order or sequence as shown to achieve the desired results. In certain implementations, multitasking and parallel processing are also possible or may be advantageous.

In summary, after reading this detailed disclosure, a person skilled in the art will understand that the foregoing detailed disclosure is presented by way of example, and is not limiting. Although not explicitly stated herein, a person skilled in the art will appreciate that the present disclosure is intended to encompass various reasonable changes, improvements, and modifications to the embodiments. These changes, improvements, and modifications are intended to be proposed by the present disclosure and are within the principles and scope of the exemplary embodiments of the present disclosure.

Furthermore, certain terms in the present disclosure have been used to describe the embodiments of the present disclosure. For example, “one embodiment,” “an embodiment,” and/or “some embodiments” mean that a particular feature, structure, or characteristic described in connection with the embodiment may be included in at least one embodiment of the present disclosure. Therefore, it may be emphasized and should be understood that two or more references to “an embodiment” or “one embodiment” or “alternative embodiment” in various parts of the present disclosure do not necessarily all refer to the same embodiment(s). Moreover, particular features, structures, or characteristics may be appropriately combined in one or more embodiments of the present disclosure.

It should be understood that in the foregoing description of the embodiments of the present disclosure, to aid in understanding one feature and for the purpose of simplifying the present disclosure, various features are combined in a single embodiment, figure, or description thereof. However, this does not mean that the combination of these features is necessary, and it is possible for a person skilled in the art, upon reading the present disclosure, to identify some of the components as separate embodiments. That is to say, embodiments in the present disclosure may also be understood as an integration of multiple sub-embodiments. This holds true even when the content of each sub-embodiment includes fewer than all the features of a single foregoing disclosed embodiment.

Each patent, patent application, publication of a patent application, and other materials, such as articles, books, specifications, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments disclosed herein are illustrative of the principles of the embodiments of the present disclosure. Other modified embodiments are also within the scope of the present disclosure. Therefore, the embodiments disclosed in the present disclosure are merely examples and not limitations. A person skilled in the art may adopt alternative configurations to implement the present disclosure based on the embodiments described herein. Thus, the embodiments of the present disclosure are not limited to the embodiments explicitly described in the present disclosure.

What is claimed is:

1. A reel, comprising:
a barrel for winding a filament, comprising a first end and a second end;
a first flange, connected to the first end, and comprising a first inner wall and a first outer wall;
a second flange, connected to the second end, and comprising a second inner wall and a second outer wall; wherein an accommodation space is formed between the first outer wall and the second outer wall; and
at least one filament clip, configured to secure a free end of the filament entirely within the accommodation space, wherein the at least one filament clip comprises:
a free end, and
a connecting end connected to the first flange.

2. The reel according to claim 1, wherein the first inner wall of the first flange comprises an accommodation recess to accommodate the at least one filament clip.

3. The reel according to claim 2, wherein the accommodation recess penetrates through the first flange along a thickness direction of the first flange.

4. The reel according to claim 2, wherein a contour of the accommodation recess matches a contour of the at least one filament clip.

5. The reel according to claim 1, wherein the at least one filament clip is plate-shaped; and
a gap is formed between the free end of the filament clip and the first inner wall, or the free end of the filament clip has a displacement by rotating around a second axis of the connecting end of the filament clip, thereby forming the gap.

6. The reel according to claim 5, wherein the at least one filament clip is 5 mm to 10 mm along the second axis and 12 mm to 18 mm perpendicular to the second axis, and the free end of the filament clip is rounded.

7. The reel according to claim 5, wherein the at least one filament clip comprises:
a first side, facing the accommodation space;
a second side, facing the first outer wall;
a filament channel, configured to allow the filament to enter from the first side, exit from the second side, and pass through the predetermined gap to remain inside the accommodation space.

8. The reel according to claim 7, wherein the filament channel comprises a restriction hole configured to allow the filament to enter from the first side and exit from the second side.

9. The reel according to claim 8, wherein the restriction hole has a major diameter in a major axis and a minor diameter in a minor axis.

10. The reel according to claim 9, wherein an angle between the major axis and a circumferential direction of the barrel is less than or equal to 45°.

11. The reel according to claim 9, wherein the major axis is perpendicular or substantially perpendicular to the second axis; or
the major axis is parallel or substantially parallel to the second axis.

12. The reel according to claim 9, wherein both ends of the restriction hole are semi-circular; and
the major diameter of the restriction hole is 3 mm to 8 mm, and the minor diameter of the restriction hole is 1.5 mm to 4 mm.

13. The reel according to claim 8, wherein the filament channel further comprises a notch in communication with the restriction hole, thereby making the filament channel hook-shaped.

14. The reel according to claim 5, wherein an angle between the second axis and a circumferential direction of the barrel is less than or equal to 45°.

15. The reel according to claim 14, wherein the at least one filament clip comprises:
a third side, facing a side of the circumferential direction;
a fourth side, facing another side of the circumferential direction; and
a filament channel configured to allow the free end of the filament to enter from the third side, exit from the fourth side, and remain inside the accommodation space.

16. The reel according to claim 15, wherein the at least one filament clip comprises a raised portion, and the raised portion forms the filament channel along the circumferential direction; or
an accommodation recess is formed on the first inner wall, and a thickness of the at least one filament clip is smaller than a depth of the accommodation recess to allow the filament to pass through the accommodation recess.

17. The reel according to claim 1, wherein the connecting end of the filament clip is integrally formed with the first flange; or
the connecting end of the filament clip is physically attached to the first inner wall.

18. The reel according to claim 1, wherein the at least one filament clip comprises at least two filament clips arranged at intervals along a circumferential direction or radial direction of the first flange.

19. A method for manufacturing a reel, comprising:
obtaining a barrel, a first flange, and a second flange;
generating at least one filament clip on the first flange; and
assembling the barrel, the first flange, and the second flange into a reel, wherein the reel comprises:
the barrel, for winding a filament, comprises a first end and a second end,
the first flange, connected to the first end, and comprising a first inner wall and a first outer wall,
the second flange, connected to the second end, and comprising a second inner wall and a second outer wall; wherein an accommodation space is formed between the first outer wall and the second outer wall, and
the at least one filament clip, configured to secure a free end of the filament entirely within the accommodation space, wherein the at least one filament clip comprises a free end and a connecting end connected to the first flange.

20. A method for manufacturing a reel, comprising:
obtaining a reel comprising a barrel, a first flange, and a second flange; and
generating at least one filament clip on the first flange, such that the reel comprises:
the barrel, for winding a filament, comprises a first end and a second end,
the first flange, connected to the first end, and comprising a first inner wall and a first outer wall,
the second flange, connected to the second end, and comprising a second inner wall and a second outer wall; wherein an accommodation space is formed between the first outer wall and the second outer wall, and
the at least one filament clip, configured to secure a free end of the filament entirely within the accommodation space, wherein the at least one filament clip comprises a free end and a connecting end connected to the first flange.
